(19) United States
(12) Patent Application Publication
(10) Pub. No.: US 2020/0024388 A1
(43) Pub. Date: Jan. 23, 2020

(54) POLYESTER RESIN COMPOSITION, AND MOLDING OF POLYESTER RESIN AND METHOD FOR PRODUCING SAME

(71) Applicants: DAIWA CAN COMPANY, Tokyo (JP); Bell Polyester Products, Inc., Yamaguchi (JP)

(72) Inventors: Yusuke ITO, Yamaguchi (JP); Tomomitsu UENO, Yamaguchi (JP); Hideaki TOMURA, Yamaguchi (JP); Masahiro YAMA, Yamaguchi (JP); Tetsuo NISHIKAWA, Yamaguchi (JP); Toshio HONMA, Yamaguchi (JP)

(21) Appl. No.: 16/335,294

(22) PCT Filed: Aug. 22, 2017
(86) PCT No.: PCT/JP2017/029902

§ 371 Date: Mar. 21, 2019

(30) Foreign Application Priority Data
Sep. 27, 2016 (JP) 2016-188300

(51) Int. Cl. C08G 63/183; C08L 67/02; C08J 5/00

(52) U.S. Cl. CPC C08G 63/183; C08L 67/02; C08J 5/00; C08L 2203/30; C08G 2140/00; C08G 2390/00; C08L 2203/16; C08G 2261/63

(57) ABSTRACT

A polyester resin composition includes a copolymer of a polycarboxylic acid component and a polyol component. The polycarboxylic acid component includes terephthalic acid and/or a derivative thereof The polyol component includes ethylene glycol and/or a derivative thereof and 2,2-dimethyl-1,3-propanediol and/or a derivative thereof. A content by percentage of 2,2-dimethyl-1,3-propanediol and/or the derivative thereof is 27 mol % to 55 mol % based on the total amount of the polyol component. The composition has an intrinsic viscosity of 0.5 dl/g to 0.6 dl/g.

### RELATED APPLICATION

The present invention is based upon and claims the benefit of the priority of Japanese Patent Application No. 2016-188300, filed on Sep. 27, 2016, the disclosure of which is incorporated herein in its entirety by reference.

### FIELD OF THE INVENTION

The present invention relates to a polyester resin composition, and a polyester resin molding and a method for producing the same. The present invention specifically relates to a polyester resin composition applicable to injection molding.

### BACKGROUND OF THE INVENTION

Polyester resin compositions are employed in various applications such as containers. Polyester resin compositions are usually molded using a mold, by injection molding, extrusion molding or the like. For example, in an injection molding method, a polyester resin composition is melted by heating or the like, and the melted composition is poured into a mold and then cooled and solidified to produce a molding.

Patent Literature 1 and Patent Literature 2, for example, disclose a copolyester molding and a copolyester that is formed of terephthalic acid as the main dicarboxylic acid component and ethylene glycol and neopentyl glycol as the main glycol components. The molding temperature (cylinder temperature) for the copolyester molding described in Patent Literature 1 is set at 230° C. to 270° C. In Examples in Patent Literature 2, copolyesters having an inherent viscosity (intrinsic viscosity) of 0.70 dl/g to 0.75 dl/g are produced.

### CITATION LIST

### Patent Literature

[Patent Literature 1] Japanese Patent Application Laid-Open No. 2011-68879

[Patent Literature 2] Japanese Patent Application Laid-Open No. 2004-123984

### DISCLOSURE OF THE INVENTION

### Problem to be Solved by the Invention

The following analysis can be given from the viewpoint of the present disclosure.

A high molding temperature, as in the case of the copolyester molding described in Patent Literature 1, requires a larger amount of energy and also requires a longer heating/cooling time. Particularly, when the molding temperature is 250° C. to 300° C., the cooling time accounts for 60% to 70% of one cycle of the molding step. Thus, in order to reduce the production cost, it is effective to lower the molding temperature to save energy, and also to shorten the cooling time.

A high molding temperature also accelerates degradation of the resin composition during molding. This leads to degradation in the quality of a molded article to be a product.

When the intrinsic viscosity is high as in the case of the copolyester described in Patent Literature 2, the temperature of the resin composition may rise during molding due to shearing heat in the cylinder of the molding apparatus. This causes the same situation as in the case in which the molding temperature is raised, leading to problems of a longer cooling time and degradation in the quality as mentioned above. Moreover, heating due to shearing heat causes temperature unevenness for every molding step, and thus, the quality of moldings may become inhomogeneous.

Even when the molding temperature is lowered, every polyester resin composition has its proper molding temperature. When the resin composition is molded at a temperature less than the proper temperature, an unmelted portion of the resin composition may occur. When the unmelted portion occurs, the transparency and physical properties may degrade, or a mold may not be sufficiently filled. On the other hand, when only the cooling time is shortened with the molding temperature unchanged, the molded article is removed from the mold while the inside of the molded article is not sufficiently cooled. Thus, the dimensions of the molded article may change. With a method in which a mold temperature during cooling is further lowered to shorten a cooling time, energy for lowering the temperature is required, and condensation occurs in the mold to generate rust.

Thus, a polyester resin composition is desired, which is moldable at a lower temperature while having desired properties. Also desired are a polyester resin molding molded at such a low molding temperature and a method for producing the same.

### Means to Solve the Problem

According to a first aspect of the present invention, a polyester resin composition comprises a copolymer of a polycarboxylic acid component and a polyol component. The polycarboxylic acid component comprises terephthalic acid and/or a derivative thereof. The polyol component comprises ethylene glycol and/or a derivative thereof and 2,2-dimethyl-1,3-propanediol and/or a derivative thereof. A content by percentage of 2,2-dimethyl-1,3-propanediol and/or the derivative thereof is 27 mol % to 55 mol % based on the total amount of the polyol component. The composition has an intrinsic viscosity of 0.5 dl/g to 0.6 dl/g.

According to a second aspect of the present invention, a polyester resin molding is provided, the molding being made by molding the polyester resin composition according to the first aspect at a set temperature of 200° C. or below.

According to a third aspect of the present invention, a method of producing a polyester resin molding is provided, the method comprising melting the polyester resin composition according to the first aspect at a set temperature of 200° C. or below, and filling a mold with the melted polyester resin composition.

### Effect of the Invention

According to the present disclosure, it is possible to provide a polyester resin composition having a low molding temperature while having desired properties. With this resin composition, it is possible to reduce costs required for molding the polyester resin composition. Particularly, the production efficiency can be enhanced.

According to the polyester resin composition of the present disclosure, it is also possible to provide a molding for which quality degradation is suppressed. According to the polyester resin composition of the present disclosure, it is possible to provide a molding of a homogeneous quality. According to the polyester resin composition of the present disclosure, it is also possible to provide a molding having desired dimensions.

### BRIEF DESCRIPTION OF THE DRAWINGS

FIG. 1 is a schematic view of a molding produced in Examples.

FIG. 2 is a schematic view for illustrating a test to check if sufficient cooling has been conducted in Examples.

FIG. 3 is a graph showing the relation between the thickness of a molding and the cooling time in Examples.

### BEST MODE FOR CARRYING OUT THE INVENTION

According to a preferred mode of the above first aspect, the polyester resin composition has a melt viscosity at 200° C. of 100 Pa·s to 210 Pa·s.

According to a preferred mode of the above first aspect, the polyester resin composition has having a melt viscosity at 180° C. of 175 Pa·s to 320 Pa·s.

According to a preferred mode of the above first aspect, the polyester resin composition has a tensile elongation of 100% or more.

According to a preferred mode of the above first aspect, the polyester resin composition has a Charpy impact strength of 3 kJ/m² or more.

According to a preferred mode of the above third aspect, the method of producing a polyester resin molding further comprises lowering the temperature of the mold to 20° C. to 60° C. to cool and demold the polyester resin composition filled in the mold. The demolded molding has a portion having a thickness of 2 mm or greater.

In the following description, reference numerals in the drawings are given for the understanding of the invention and are not intended to limit the invention to the aspects shown. Furthermore, the shape, dimension, scale and the like shown do not limit the invention to the aspects shown in the drawings. The same reference numerals are given to the same elements in each embodiment.

A polyester resin composition of the present disclosure according to a first embodiment will be described. The composition of the present disclosure is a polyester resin as a copolymer of a polycarboxylic acid component and a polyol component (polyhydroxy compound). In the present disclosure, the polycarboxylic acid refers to a compound having a plurality of carboxyl groups. The polyol component or polyhydroxy compound refers to a compound having a plurality of hydroxyl groups.

The polycarboxylic acid component mainly comprises terephthalic acid (including a derivative thereof). The polycarboxylic acid component preferably further comprises trimellitic acid and/or trimellitic anhydride (including a derivative thereof). The content of trimellitic acid and/or trimellitic anhydride is preferably 0.4 mol % or less and more preferably 0.3 mol % or less based on the total amount of the polycarboxylic acid component. When the content exceeds 0.5 mol %, sufficient mechanical physical properties may not be achieved.

The polycarboxylic acid component in the composition of the present disclosure is terephthalic acid, or preferably terephthalic acid and trimellitic acid and/or trimellitic anhydride. However, the composition of the present disclosure may contain other polycarboxylic acid components as long as the substantial nature of the composition of the present disclosure is not altered. Examples of the other polycarboxylic acid components may include isophthalic acid, orthophthalic acid, 2,6-naphthalenedicarboxylic acid, adipic acid, sebacic acid, succinic acid, dimer acids, 1,4-cyclohexanedicarboxylic acid, dimethyl terephthalate, dimethyl isophthalate and derivatives thereof. Of these, isophthalic acid is preferable. Any one of these other polycarboxylic acid components may be added singly, or two or more of these may be added at an optional ratio.

The polyol component mainly comprises ethylene glycol (including a derivative thereof) and 2,2-dimethyl-1,3-propanediol (neopentyl glycol) (including a derivative thereof). The content of neopentyl glycol is preferably 27 mol % or more, more preferably 30 mol % or more, more preferably 35 mol % or more, and still more preferably 40 mol % or more, based on the total amount of the polyol component. When the content is 25 mol % or less, the molding temperature of the composition exceeds 200° C. The content of neopentyl glycol is preferably 55 mol % or less, more preferably 52 mol % or less, more preferably 50 mol % or less, and still more preferably 45 mol % or less, based on the total amount of the polyol component. When the content exceeds 55 mol %, sufficient mechanical physical properties may not be achieved.

The polyol component in the composition of the present disclosure is preferably ethylene glycol and neopentyl glycol. The composition of the present disclosure, however, may contain other polyol components as long as the substantial nature of the composition of the present disclosure is not altered. Examples of the other polyol components may include 1,3-propanediol, 2-methyl-1,3-propanediol, 2-butyl-2-ethyl-1,3-propanediol, 1,2-propanediol, 1,4-butanediol, 1,3-butanediol, diethylene glycol, 1,4-cyclohexanediol, 1,4-cyclohexanedimethanol and derivatives thereof. Of these, 1,4-cyclohexanedimethanol is preferable. Any one of these other polyol components may be added singly, or two or more of these may be added at an optional ratio.

The intrinsic viscosity (IV value) of the composition of the present disclosure is preferably higher than 0.48 dl/g (10² cm³/g) and more preferably 0.50 dl/g or more. When the intrinsic viscosity is 0.48 dl/g or less, sufficient mechanical physical properties may not be achieved. The intrinsic viscosity (IV value) of the composition of the present disclosure is preferably less than 0.65 dl/g, more preferably 0.63 dl/g or less, and still more preferably 0.60 dl/g or less. When the intrinsic viscosity is 0.65 dl/g or more, the melt viscosity at 200° C. becomes too large, and thus, the temperature of the composition during molding rises due to shearing heat. This temperature rise prolongs the cooling time.

The intrinsic viscosity is an intrinsic viscosity at 20° C. measured by dissolving 0.5000±0.0005 g of a sample in a mixed solvent of phenol:tetrachloroethane=60:40 (mass ratio) and using an automatic viscosity measuring device equipped with an Ubbelohde viscometer.

The melt viscosity at 200° C. of the composition of the present disclosure is preferably higher than 95 Pa·s and more preferably 100 Pa·s or more. When the melt viscosity is 95 Pa·s or less, sufficient mechanical physical properties may not be achieved. The melt viscosity at 200° C. of the composition of the present disclosure is preferably 210 Pa·s or less and more preferably 200 Pa·s or less. When the melt viscosity exceeds 210 Pa·s, the temperature of the composition during molding rises due to shearing heat. This temperature rise prolongs the cooling time.

When the content of neopentyl glycol is 35 mol % to 45 mol % based on the total amount of the polyol component, the melt viscosity at 180° C. of the composition of the present disclosure is preferably 175 Pa·s or more, more preferably 180 Pa·s or more, and still more preferably 200 Pa·s or more. When the melt viscosity at 180° C. is less than 175 Pa·s, sufficient mechanical physical properties may not be achieved. The melt viscosity at 180° C. of the composition of the present disclosure is preferably 320 Pa·s or less, more preferably 300 Pa·s or less, and still more preferably 260 Pa·s or less. When the melt viscosity at 180° C. exceeds 320 Pa·s, the temperature of the composition during molding rises due to shearing heat. This temperature rise prolongs the cooling time.

The melt viscosities at 180° C. and 200° C. are melt viscosities measured for 20.0±5.0 g of each dried composition at measuring temperatures of 180° C. and 200° C., respectively, and a shear rate of 6080 sec⁻¹, using a melt viscosity measuring device. No particular limitation is imposed on the method for drying the composition. For example, the composition can be dried using a dehumidifier dryer under conditions of 60° C. and 48 hours.

The tensile strength of the composition of the present disclosure is preferably 40 MPa or more and more preferably 45 MPa or more. When the tensile strength is less than 40 MPa, sufficient mechanical physical properties may not be achieved. The tensile strength is preferably measured in accordance with ISO (International Organization for Standardization) 527.

The tensile elongation of the composition of the present disclosure is preferably more than 60%, more preferably 80% or more, and still more preferably 100% or more. When the tensile elongation is 60% or less, sufficient mechanical physical properties may not be achieved. The tensile elongation is preferably measured in accordance with ISO 527.

The Charpy impact strength of the composition of the present disclosure is preferably more than 2.8 kJ/m², more preferably 3 kJ/m² or more, and still more preferably 3.2 kJ/m² or more. When the Charpy impact strength is 2.8 kJ/m² or less, sufficient mechanical physical properties may not be achieved. The Charpy impact strength is preferably measured in accordance with ISO 179.

The composition of the present disclosure can further contain a dye. As such a dye, organic dyes are preferable, and oil-soluble dyes such as polyaromatic ring-based dyes are more preferable. As the organic dyes, known organic dyes (such as blue dyes, red dyes, violet dyes and orange dyes) may be used. One dye may be used singly, or dyes of different colors may be used in combination. Particularly, a combination of a blue dye and a red dye is preferable because the combination can reduce the yellowish color of a polyester resin, thereby providing a near-colorless color tone. Examples of the blue dyes that can be used may include C.I. Solvent Blue 11, C.I. Solvent Blue 25, C.I. Solvent Blue 35, C.I. Solvent Blue 36, C.I. Solvent Blue 45, C.I. Solvent Blue 55, C.I. Solvent Blue 63, C.I. Solvent Blue 78, C.I. Solvent Blue 83, C.I. Solvent Blue 87, C.I. Solvent Blue 94, C.I. Solvent Blue 97 and C.I. Solvent Blue 104. Examples of the red dyes that can be used may include C.I. Solvent Red 24, C.I. Solvent Red 25, C.I. Solvent Red 27, C.I. Solvent Red 30, C.I. Solvent Red 49, C.I. Solvent Red 52, C.I. Solvent Red 100, C.I. Solvent Red 109, C.I. Solvent Red 111, C.I. Solvent Red 121, C.I. Solvent Red 135, C.I. Solvent Red 168, C.I. Solvent Red 179 and C.I. Solvent Red 195. Examples of the violet dyes that can be used may include C.I. Solvent Violet 8, C.I. Solvent Violet 13, C.I. Solvent Violet 14, C.I. Solvent Violet 21, C.I. Solvent Violet 27, C.I. Solvent Violet 28 and C.I. Solvent Violet 36. Examples of the orange dyes that can be used may include C.I. Solvent Orange 60.

The composition of the present disclosure may further contain a polymerization catalyst. Examples of the polymerization catalyst may include germanium compounds, titanium compounds and the like.

The composition of the present disclosure may further contain a phosphorus compound. The phosphorus compound can be used as a heat stabilizer, for example. Examples of the phosphorus compound may include orthophosphoric acid; pentavalent phosphate compounds such as trimethyl phosphate, triethyl phosphate and trioctyl phosphate; phosphorous acid; and trivalent phosphorus compounds such as trimethyl phosphite and triethyl phosphite. Of these, orthophosphoric acid, trimethyl phosphate and triethyl phosphate are preferable. From the viewpoint of food hygiene and safety, orthophosphoric acid or triethyl phosphate is more preferable. The phosphorus compound is preferably added within the range where the reactivity of the polymerization catalyst is not inhibited. For example, the content of the phosphorus compound is preferably 100 ppm or less based on the mass of the composition.

The composition of the present disclosure may contain known additives such as an antistatic agent, an ultraviolet absorber, a heat stabilizer, a mold release agent, an antioxidant and the like as long as the substantial nature of the composition of the present disclosure is not altered.

The composition of the present disclosure may include a polyester resin composition that is obtained by a production method described below. Some characteristics of the composition of the present disclosure other than those mentioned above may be difficult to identify directly by the structure or properties of the composition of the present disclosure. In such a case, it is useful to identify such characteristics from the production method.

The polyester resin composition of the present disclosure has a low moldable temperature (temperature at which the resin reaches a moldable state) while maintaining sufficient mechanical physical properties. For example, the composition of the present disclosure can be used for injection molding for which the cylinder temperature is set at 200° C. As a result, it is possible to reduce energy required for molding. Additionally, the cooling time, in particular, can be shortened, and thus, it is possible to enhance the production efficiency. Accordingly, it is possible to reduce the molding cost. Keeping the molding temperature low can inhibit the resin composition in a melt state from decomposing. This inhibition also can inhibit the quality of a molding from degrading. Furthermore, keeping the intrinsic viscosity low can inhibit occurrence of temperature unevenness, which is caused by shearing heat in a melt state. This inhibition can provide a homogeneous quality of molded articles.

Subsequently, as a second embodiment, a method for producing a polyester resin composition of the present disclosure will be described.

The polyester resin composition of the present disclosure can be produced from the monomers and additives by a known method. For example, an ester prepolymer may be generated by a direct esterification using an unsubstituted polycarboxylic acid as a starting material, or an ester prepolymer may be generated by a transesterification reaction using an esterified product such as dimethyl ester as a starting material. From the viewpoint of the production efficiency, the direct esterification reaction is preferably selected.

The ratios of the monomers and additives to be added can be the ratios shown in the description for the composition of the present disclosure.

The transesterification reaction can be conducted by, for example, placing raw materials into a reaction vessel equipped with a heater, a stirrer and a distillation tube, adding a reaction catalyst to the vessel, raising the temperature with stirring under atmospheric pressure and inert gas atmosphere, and allowing the reaction to proceed while a byproduct such as methanol generated by the reaction is distilled off. The reaction temperature can be, for example, 150° C. to 270° C. and is preferably 160° C. to 260° C. The reaction time is, for example, of the order of 3 to 7 hours.

As the catalyst for the transesterification reaction, at least one or more metal compounds may be used. Examples of preferable metal elements may include sodium, potassium, calcium, titanium, lithium, magnesium, manganese, zinc, tin, cobalt and the like. Of these, titanium and manganese compounds are preferable because of their high reactivity and satisfactory color tones of resins to be obtained. The amount of the transesterification catalyst to be added is usually preferably 5 ppm to 1000 ppm and more preferably 10 ppm to 100 ppm relative to a polyester resin to be generated.

It is desirable that, after the transesterification reaction is completed, a phosphorus compound be added in an equimolar amount or more relative to the transesterification catalyst and esterification reaction be allowed to further proceed. Examples of the phosphorus compound may include phosphoric acid, phosphorous acid, trimethyl phosphate, triethyl phosphate, tributyl phosphate, trimethyl phosphite, triethyl phosphite, tributyl phosphite and the like. Of these, trimethyl phosphate is particularly preferred. The amount of the phosphorus compound to be used is preferably 5 ppm to 1000 ppm and more preferably 20 ppm to 100 ppm based on the mass of the polyester resin to be generated.

Of the polyol components in the present invention, neopentyl glycol may be added in the course of the direct esterification reaction of the polycarboxylic acid component and ethylene glycol or may be added after the esterification reaction is completed. It is preferred to mix a polycarboxylic acid component, ethylene glycol and neopentyl glycol in advance at normal temperature to prepare a slurry and then, allow the esterification reaction to proceed in an esterification vessel because scattering of neopentyl glycol may be suppressed.

Following the transesterification reaction and esterification reaction, a polymerization catalyst may be added to the ester prepolymer to conduct a polycondensation reaction until a desired molecular weight is achieved. As the catalyst in the polymerization reaction, for example, germanium dioxide may be used. The proportion of the catalyst to be added may be 180 ppm to 220 ppm, for example, based on the amount of the resin to be produced. The polycondensation reaction can be conducted, for example, after addition of a polymerization catalyst, while the temperature is raised and the pressure is reduced gradually inside the reaction vessel. It is preferred that the pressure inside the vessel be eventually reduced to 0.4 kPa or less, for example, and preferably 0.2 kPa or less. It is preferred that the temperature inside the vessel be eventually raised to 250° C. to 290° C., for example. The polymerization reaction can be conducted until a predetermined melt viscosity is achieved under a reduced pressure corresponding to the final pressure inside the vessel of 150 Pa or less, for example. Thereafter, the pressure inside the vessel is raised to 0.5 MPa, for example. The reaction product can be extruded and collected from the bottom of the vessel. For example, the reaction product can be extruded in a strand form into water and cut after cooling, thereby providing a polyester resin composition in a pellet form.

As the polymerization catalyst, catalysts other than germanium dioxide may also be used. For example, titanium dioxide may be used as the polymerization catalyst. When titanium dioxide is used, the proportion of the catalyst to be added is 1 ppm to 10 ppm, for example, based on the amount of the resin to be produced.

To the polyester resin composition of the present invention, various additives such as an antioxidant, a heat stabilizer, a lubricant, an antistatic agent, a plasticizer, an ultraviolet absorber and a pigment may be appropriately blended depending on applications and purposes for molding. These additives may be blended in any step of the polymerization reaction step and processing/molding step. Examples of the antioxidant may include hindered phenol antioxidants, phosphorus antioxidants, sulfur antioxidants and the like, and hindered phenol antioxidants are particularly preferable. The amount of the antioxidant to be added is desirably of the order of 100 ppm to 5000 ppm. In forming of a melt-extruded film, a metal salt such as magnesium acetate, calcium acetate, magnesium chloride and the like may be added in order to stabilize the electrostatic adhesion of chill rolls.

According to the method for producing a polyester resin composition of the present disclosure, it is possible to produce a composition having the properties mentioned above.

As a third embodiment, a method for producing a polyester resin molding of the present disclosure will be described. As the method for producing a polyester resin molding, injection molding may be employed, for example.

First, the polyester resin composition according to the first embodiment is melted. The set temperature of a heater (e.g., a cylinder) for melting the polyester resin composition is a temperature at which no unmelted portion of the composition occurs. The set temperature of the heater is preferably 220° C. or less and more preferably 200° C. or less. Depending on compositions, the temperature may be 180° C. or less. Lowering the heating temperature can shorten the cooling time to enhance the production efficiency as well as can inhibit the quality from degrading. The polyester resin composition of the present disclosure, which has a low intrinsic viscosity, can inhibit the temperature of the composition from markedly departing from the set temperature due to shearing heat. The polyester resin composition can also inhibit occurrence of temperature unevenness in the melt.

Secondly, a mold is filled with the melted composition. The mold can be maintained at a predetermined temperature. The temperature of the mold may be set at, for example, 20° C. to 60° C., preferably at 30° C. to 50° C. Setting the temperature of the mold at less than 20° C. requires a large amount of energy for cooling. Moreover, condensation occurs in the mold, thereby accelerating degradation of the mold. The mold is preferably cooled with water.

Thirdly, the composition filled in the mold is molded while retained with the mold for a predetermined time. After molding, the molding is demolded. The retention time from pouring the resin into the mold until demolding is the cooling time (molding time). The cooling time depends on the size, particularly the thickness of the molding.

According to the method for producing a polyester resin molding of the present disclosure, it is possible to reduce the production cost by reduction in the energy consumption and enhancement in the production efficiency. It is also possible to produce high quality moldings having a homogeneous quality.

As a fourth embodiment, a polyester resin molding of the present disclosure will be described.

The polyester resin molding of the present disclosure is a molding produced by the production method according to the third embodiment. For example, the polyester resin molding of the present disclosure may be a molding obtained by melting the polyester resin composition according to the first embodiment at a set temperature of 200° C. or less and molding the resultant. The molding of the present disclosure has preferably a portion having a thickness of 2 mm or more, more preferably a portion having a thickness of 3 mm or more, and still more preferably a portion having a thickness of 5 mm or more. When the molding has a portion having a thickness of 2 mm or more, it is possible to shorten the cooling time more effectively. For example, when the molding has a thickness of 5 mm, molding may be conducted at a heating temperature of 180° C., in a mold at 20° C. to 60° C. for a cooling time of about 20 seconds. The thickest portion in the molding of the present disclosure may have a thickness of 10 mm or less. When the molding has a thickness of 10 mm, molding may be conducted at a heating temperature of 180° C., in a mold at 20° C. to 60° C. for a cooling time of about 75 seconds.

The composition and properties of the molding may be changed from those of the composition depending on the heating melt conditions in producing the molding. The composition and properties of the molding may be difficult to identify directly in some cases. In such cases, it is useful to identify the molding by means of the production method from a composition to the molding.

The polyester resin molding of the present disclosure, which has been molded at a low temperature, can have a quality of less deterioration from the composition. The polyester resin molding of the present disclosure, which is not affected by unevenness of heat generation due to shearing heat, can have a homogeneous quality. The polyester resin molding of the present disclosure can have desired dimensions even with a short cooling time.

Hereinafter, the polyester resin composition of the present disclosure will be described with reference to Examples. The polyester resin composition of the present disclosure is not intended to be limited to the following Examples.

### EXAMPLES

### Examples 1 to 4 and Comparative Examples 1 to 4

Polyester resin compositions were produced, and the intrinsic viscosity, mechanical physical properties, melt viscosity and moldability of each composition were measured. The compositions and measurement results of Examples 1 to 4 are shown in Table 1. Polyester resin compositions each having a different composition and intrinsic viscosity were also produced as Comparative Examples, and measurements were conducted in a similar manner. The compositions and measurement results of Comparative Examples 1 to 4 are shown in Table 2.

### [Production of Polyester Resin Compositions]

In a 30 L autoclave, terephthalic acid (TPA), ethylene glycol (EG) and neopentyl glycol (NPG) of each composition shown in Table 1 were placed, and esterified under a nitrogen flow and an atmospheric pressure condition at 250° C. The ratios blended shown in Table 1 represent the proportion of the polycarboxylic acid component blended and the proportion of the polyol component blended. Subsequently, the pressure was reduced inside the reaction vessel over an hour, and polycondensation reaction was conducted, using germanium dioxide as a polymerization catalyst, under a reduced pressure of 100 Pa or less at 270° C. until a predetermined viscosity was achieved. The reaction product was extruded from the reaction vessel into water, and the extrudate was cut by a pelletizer to obtain resin pellets. The polyester resin composition generated was subjected to the following measurements. In the Comparative Examples, polyester resin compositions were produced with compositions shown in Table 2 by the same production method as in the Examples and subjected to the same measurements as in the Examples.

### [Measurement of Intrinsic Viscosity]

For each polyester resin composition, 0.5000 g±0.0005 g of a sample was dissolved in a mixed solvent of phenol:tetrachloroethane=60:40 (mass ratio), and the intrinsic viscosity at 20° C. was measured using an automatic viscosity measuring device (manufactured by SUN Electronic Industries Corporation, ALC-6C) equipped with an Ubbelohde viscometer.

### [Measurement of Moldability and Cooling Time]

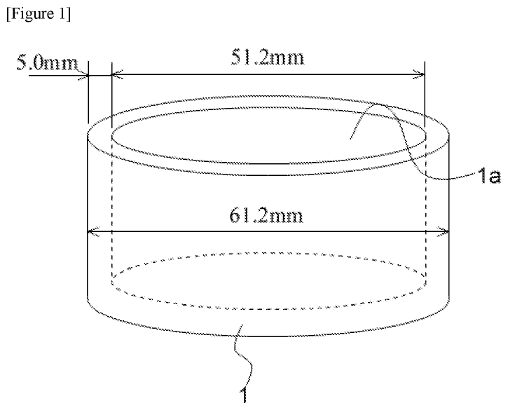

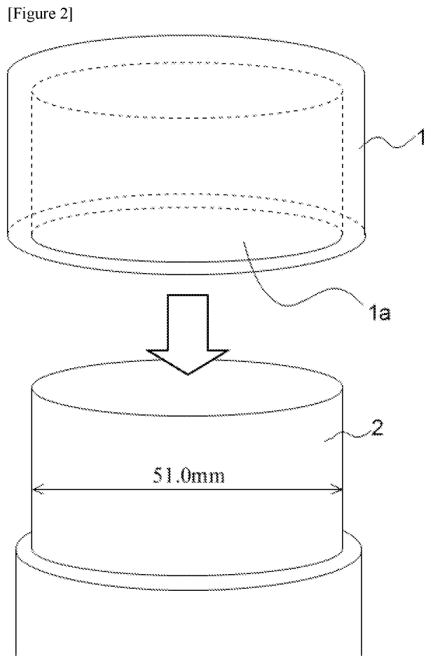

Each dried polyester resin composition was supplied in a hopper, and the resin composition weighed during 12 seconds of a weighing time was injection molded by using a 130-ton injection molding machine (manufactured by Sumitomo Heavy Industries, Ltd., SE130DUZ-HP) at a molding temperature of 180° C. or 200° C. by using a 50° C. mold under cooling with water. A schematic view of the molding is shown in FIG. 1. The dimensions shown in FIG. 1 are target values. A molding 1 has a bottomed cylinder shape (cylindrical vessel shape) having an inner diameter of 51.2 mm and a thickness (wall thickness) of 5.0 mm. The set temperature of the cylinder is a set temperature in the molding injection machine. The molding temperature was basically set at 180° C., but when the resin composition was not melted at 180° C., the temperature was raised to 200° C. The measured temperature of the cylinder was measured with a thermometer attached to the cylinder. After the resin was injected from the cylinder, the measured temperature of the resin was determined by measuring the temperature of the resin immediately after injection with an infrared thermometer. The cooling time was measured as the time from injection of the melted resin into the mold to demolding of the molding 1. A schematic view for illustrating a test to check if sufficient cooling has been conducted is shown in FIG. 2. The shortest cooling time was determined as the time at which a mold for checking 2 having an outer diameter of 51.0 mm for use in checking if the molding 1 is sufficiently cooled in molding, was enabled to fit, up to a predetermined position, into an opening 1a of the molding 1 one day after demolding. When cooling was sufficiently conducted in molding, contraction of the molding 1 after demolding is small, and thus, it is possible to allow the mold for checking 2 to fit, up to a predetermined position, into the opening 1a of the molding 1. In contrast, when cooling was insufficiently conducted in molding, contraction of the molding 1 after demolding is large, and thus, it is not possible to allow the mold for checking 2 to fit, up to a predetermined position, into the opening 1a of the molding 1. After the outer diameter of the molded article 1 one day after demolding was measured, the molding contraction rate was calculated by the following expression. The average outer diameter of the molded article is an average value of the outer diameter of 20 moldings 1 successively molded under the same conditions.

Molding contraction rate=(inner diameter of mold−average outer diameter of molded article)/inner diameter of mold×100

### [Measurement of Melt Viscosity]

Each composition as a sample was dried using a dehumidifier dryer at 60° C. for 48 hours. Then, 20.0 g±5.0 g of each dried composition was weighed, and the melt viscosity was measured using a melt viscosity measuring device at a measurement temperature of 200° C. and a shear rate of 6080 sec⁻¹.

### [Measurement of Mechanical Physical Properties]

The tensile strength and tensile elongation were measured on each composition in accordance with ISO 527. The tensile elongation was measured on five samples, and the average value was calculated. Additionally, the Charpy impact strength was measured on each composition in accordance with ISO 179. The Charpy impact strength was measured on 10 samples, and the average value was calculated.

### [Measurement Results]

In Examples 1 to 4, it was possible to provide the shortest cooling time of 25 seconds or less. It was possible to provide a melt viscosity at 200° C. of 100 Pa·s to 200 Pa·s. It was possible to provide a melt viscosity at 180° C. of 180 Pa·s to 300 Pa·s. It was possible to make the resin temperature during molding to be within 4% of the set temperature. It was possible to provide a tensile strength of 40 MPa or more and a tensile elongation of 100% or more of the composition. It was also possible to provide a Charpy impact strength of the composition of 3 kJ/m² or more. Thus, according to the polyester resin composition of the present disclosure, it was possible to shorten the molding time while the mechanical physical properties of the molding were maintained. The shortest cooling time was determined so as not to cause contraction after demolding, and thus, the molding contraction ratios both in the Examples and the Comparative Examples were small.

In Comparative Example 1, in which the rate of neopentyl glycol added was 25 mol %, the shortest cooling time was 35 seconds. Thus, it was not possible to shorten the cooling time. This seems to be because, in one regard, the melt viscosity at 200° C. was as high as 235 Pa·s and the temperature of the composition during molding was maintained due to shearing heat. In contrast, in Examples 1 to 4, in which the rate of neopentyl glycol added was 30 mol % or more, the melt viscosity at 200° C. was 200 Pa/s or less, and it was possible to make the shortest cooling time 20 seconds or less. Accordingly, the rate of neopentyl glycol added seems to be preferably more than 25 mol % and more preferably 30 mol % or more based on the total amount of the polyol component.

In Comparative Example 4, in which the rate of neopentyl glycol added was 57 mol %, the melt viscosities were as low as 92 Pa·s at 200° C. and 170 Pa·s at 180° C. Moreover, the tensile elongation was 60%, and thus, it was not possible to provide a sufficient mechanical strength. In contrast, in Examples 1 to 4, in which the rate of neopentyl glycol added was 55 mol % or less, it was possible to provide a melt viscosity at 200° C. of 100 Pa·s or more and a melt viscosity at 180° C. of 180 Pa·s or more. Additionally, the tensile elongation was 100% or more, and thus, it was possible to provide sufficient mechanical physical properties. Accordingly, the rate of neopentyl glycol added seems to be preferably 55 mol % or less and more preferably 50 mol % or less based on the total amount of the polyol component.

In Comparative Example 2, in which the intrinsic viscosity was 0.48 dl/g, the melt viscosities were as low as 95 Pa·s at 200° C. and 164 Pa·s at 180° C. Moreover, the tensile elongation was 30% and the Charpy impact strength was 2.5 kJ/m². Thus, it was not possible to provide a sufficient mechanical strength. In contrast, in Examples 1 to 4, in which the intrinsic viscosity was 0.50 dl/g or more, it was possible to provide a melt viscosity at 200° C. of 100 Pa·s or more and a melt viscosity at 180° C. of 180 Pa·s or more. Additionally, the tensile elongation was 100% or more, and thus, it was possible to provide sufficient mechanical physical properties. Accordingly, the intrinsic viscosity seems to be preferably 0.50 dl/g or more.

In Comparative Example 3, in which the intrinsic viscosity was 0.65 dl/g, the shortest cooling time was as long as 30 seconds. This seems to be because, since the intrinsic viscosity was high, the resin temperature during molding became higher, due to shearing heat, than the cylinder set temperature by about 20° C. (8% or more). Additionally, the melt viscosities were as high as 251 Pa·s at 200° C. and 330 Pa·s at 180° C., and the shearing heat seems to have adversely affected the cooling rate. In contrast, in Examples 1 to 4, in which the intrinsic viscosity was 0.58 dl/g or less, heat generation due to shearing heat had slight influence. Thus, it was possible to suppress the increase in the resin temperature during molding within 4% of the set temperature. Additionally, the melt viscosity at 200° C. was 180 Pa·s or less, and the melt viscosity at 180° C. was 290 Pa·s or less. Thus, shearing heat seems to have slightly affected the cooling rate. For this reason, it seems that it was possible to provide a cooling time of 25 seconds or less in each Example. Accordingly, the intrinsic viscosity seems to be preferably less than 0.65 dl/g and more preferably 0.60 dl/g or less.

With respect to the moldings obtained in Examples 1 to 4, it seems that it was possible not only to shorten the molding time but also to inhibit the quality of the moldings from degrading by lowering the resin temperature during molding. Additionally, the influence due to shearing heat was small, and thus, it was possible to provide a stable quality.

TABLE 1

| | | | Example 1 | Example 2 | Example 3 | Example 4 |
|---|---|---|---|---|---|---|
| Composition | Polycarboxylic acid | TPA | 100 | 100 | 100 | 100 |
| (mol %) | component | | | | | |
| | Polyol component | EG | 67 | 60 | 60 | 50 |
| | | NPG | 33 | 40 | 40 | 50 |

| Intrinsic viscosity (dl/g) | | 0.51 | 0.52 | 0.58 | 0.58 |
|---|---|---|---|---|---|
| Moldability | Cylinder set temperature (° C.) | 180 | 180 | 180 | 180 |
| | Measured temperature of cylinder (° C.) | 183 | 180 | 180 | 180 |
| | Measured temperature of resin (° C.) | 187 | 185 | 186 | 186 |
| | Shortest cooling time (seconds) | 23 | 19 | 20 | 20 |
| | Molding contraction rate (%) | 0.33 | 0.32 | 0.32 | 0.33 |

| Melt viscosity (Pa · s) | 200° C. | 111 | 112 | 176 | 173 |
|---|---|---|---|---|---|
| | 180° C. | 289 | 183 | 255 | 240 |

| | | | | | |
|---|---|---|---|---|---|
| Mechanical | Tensile strength (MPa) | 44 | 45 | 47 | 43 |
| physical | Tensile elongation (%) | ≥100 | ≥100 | ≥200 | ≥100 |
| property | Charpy impact strength | 3.1 | 3.2 | 4.0 | 3.1 |
| | (kJ/m²) | | | | |

TABLE 2

| | | | Comparative | Comparative | Comparative | Comparative |
|---|---|---|---|---|---|---|
| | | | Example 1 | Example 2 | Example 3 | Example 4 |
| Composition | Polycarboxylic acid | TPA | 100 | 100 | 100 | 100 |
| (mol %) | component | | | | | |
| | Polyol component | EG | 70 | 60 | 60 | 43 |
| | | NPG | 25 | 40 | 40 | 57 |

| Intrinsic viscosity (dl/g) | | 0.55 | 0.48 | 0.65 | 0.53 |
|---|---|---|---|---|---|
| Moldability | Cylinder set temperature (° C.) | 200 | 180 | 180 | 180 |
| | Measured temperature of cylinder (° C.) | 205 | 180 | 187 | 180 |
| | Measured temperature of resin (° C.) | 212 | 184 | 196 | 183 |
| | Shortest cooling time (seconds) | 35 | 20 | 30 | 19 |
| | Molding contraction rate (%) | 0.33 | 0.32 | 0.33 | 0.33 |

| Melt viscosity (Pa · s) | 200° C. | 235 | 95 | 251 | 92 |
|---|---|---|---|---|---|
| | 180° C. | Not | 164 | 330 | 170 |
| | | measurable | | | |

| | | | | | |
|---|---|---|---|---|---|
| Mechanical | Tensile strength (MPa) | 48 | 47 | 45 | 44 |
| physical | Tensile elongation (%) | ≥100 | 30 | ≥200 | 60 |
| property | Charpy impact strength | 3.3 | 2.5 | 4.2 | 3.2 |
| | (kJ/m²) | | | | |

### Examples 5 and 6 and Comparative Examples 5 and 6

### [Influence of Cooling Time on Moldability]

The polyester resin composition of the present disclosure was molded in a shorter time than the shortest cooling time, and the influence on a molding was examined. Compositions used are the compositions of Examples 2 and 3. The composition of Example 2 was used in Example 5 and Comparative Example 5, and the composition of Example 3 was used in Example 6 and Comparative Example 6. In Examples 5 and 6, the cooling time was set at 20 seconds based on Examples 2 and 3. In Comparative Examples 5 and 6, the cooling time was set at 15 seconds. The compositions, molding conditions and results are shown in Table 3. The molding conditions, molding contraction ratio, and measurement method for fitting into a mold were the same as in the methods mentioned in Examples 1 to 4 except for the cooling time.

In Examples 5 and 6, the molding contraction rate was 0.33% or less, and the mold for checking was enabled to fit into the opening of the molding. In contrast, in Comparative Examples 5 and 6, the molding contraction rate was as high as 0.35% or more, and thus it was not possible to allow the mold for checking to fit, up to a predetermined position, into the opening of the molding. Moldings that prevent fitting of the mold for checking therein are considered defective products. Accordantly, it has been revealed that only shortening the cooling time merely leads to production of defective products and fails to enhance the production efficiency.

If the same test is conducted using the composition according to Comparative Example 3, defective moldings not capable of fitting onto the mold for checking are produced even with a cooling time of 20 seconds.

TABLE 3

| | | | |
|---|---|---|---|
| | | Comparative | Comparative |
| Example 5 | Example 6 | Example 5 | Example 6 |

| | | | |
|---|---|---|---|
| Composition | Polycarboxylic acid | TPA | 100 |
| (mol %) | component | | |
| | Polyol component | EG | 60 |
| | | NPG | 40 |

| Intrinsic viscosity (dl/g) | | 0.52 | 0.58 | 0.52 | 0.58 |
|---|---|---|---|---|---|
| Moldability | Cylinder set temperature (° C.) | 180 | | | |
| | Cooling time (seconds) | 20 | | 15 | |
| | Molding contraction rate (%) | 0.32 | 0.33 | 0.35 | 0.39 |
| | Fitting onto mold | Yes | Yes | No | No |

### Examples 7 to 9

### [Influence of Thickness of Molding on Cooling Time]

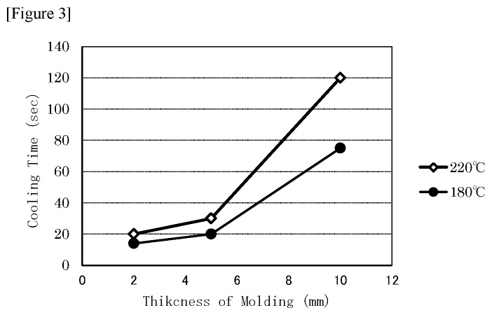

With respect to the polyester resin composition of the present disclosure, influence of the thickness (wall thickness) of moldings to be produced on the cooling time was examined. The composition according to Example 2 was used to produce moldings each having thickness of 2 mm, 5 mm, or 10 mm, and the cooling time to be required for each molding was measured. The molding having a thickness of 2 mm was in a rectangular flat-plate shape of 90 mm in length, 50 mm in width, and 2 mm in thickness. In this molding, asperities (for example, sink marks) occur due to thermal contraction when the cooling time is insufficient. Then, the cooling times in Examples 7-1 and 7-2 were determined as the shortest cooling time at which no asperity occurred on the molding. The molding having a thickness of 5 mm is the same as the moldings in Examples 1 to 4, and the cooling time is measured in the same manner. The molding having a thickness of 10 mm had the shape shown in FIG. 1 and had the same inner diameter as the inner diameter shown in FIG. 1. The cooling time was measured in the same manner as for the molding having a thickness of 5 mm. With the cylinder set temperatures of 180° C. and 220° C., the shortest cooling temperature was measured at each temperature. The results are shown in Table 4. A graph obtained by plotting the cooling time against the wall thickness is shown in FIG. 3.

The larger the wall thickness of the molding, the longer the cooling time is required. Lowering the cylinder set temperature, that is, the heating temperature has enabled the cooling time to be shortened. Additionally, the difference in the cooling time between the heating temperatures of 180° C. and 220° C. has increased depending on the wall thickness. Accordingly, as mentioned above, it can be seen that use of the composition of the present disclosure can lower the resin temperature during molding and that this lowering can enhance the production efficiency of the molding. Particularly, when a plurality of identical moldings is successively produced, shortening of the production time and reduction in the energy cost become enormous. Such an effect becomes higher as the wall thickness of the molding increases.

If the same tests as in Examples 7 to 9 are conducted using the composition according to Comparative Example 3, a longer cooling time is required.

TABLE 4

| | Wall thickness | Cylinder set | Cooling | Difference |
|---|---|---|---|---|
| | of molding | temperature | Time | in cooling time |
| | (mm) | (° C.) | (seconds) | (seconds) |
| Example 7-1 | 2 | 180 | 14 | +6 |
| Example 7-2 | | 220 | 20 | |
| Example 8-1 | 5 | 180 | 20 | +10 |
| Example 8-2 | | 220 | 30 | |
| Example 9-1 | 10 | 180 | 75 | +45 |
| Example 9-2 | | 220 | 120 | |

### Example 10

### [Influence of Polymerization Catalyst on Physical Properties]

In Examples 1 to 4, polyester resin compositions were produced using germanium dioxide (GeO₂) (200 ppm based on the mass of the polyester resin composition) as a polymerization catalyst. In Example 10, a polyester resin composition was produced using 2 ppm of titanium dioxide (TiO₂) based on the mass of the polyester resin composition as the polymerization catalyst, instead of germanium dioxide. The polyester resin composition was produced in the same manner as in Examples 1 to 4 except for the polymerization catalyst. The polyester resin composition obtained was subjected to measurement of moldability and physical properties in the same manner as in Examples 1 to 4. The composition and measurement results are shown in Table 5.

The composition according to Example 5, which has the same composition and intrinsic viscosity as those of the composition according to Example 2, was enabled to have also moldability, melt viscosity and mechanical physical properties comparable to those of the composition according to Example 2. Accordingly, the effect of the polyester resin composition of the present disclosure seems not to depend on the polymerization catalyst.

TABLE 5

| | | | Example 5 |
|---|---|---|---|
| Composition | Polycarboxylic acid component | TPA | 100 |
| (mol %) | Polyol component | EG | 60 |
| | | NPG | 40 |

| Intrinsic viscosity (dl/g) | | 0.52 |
|---|---|---|
| Moldability | Cylinder set temperature (° C.) | 180 |
| | Measured temperature of cylinder (° C.) | 180 |
| | Measured temperature of resin (° C.) | 185 |
| | Shortest cooling time (seconds) | 20 |
| | Molding contraction rate (%) | 0.32 |
| Melt viscosity | 200° C. | 112 |
| (Pa · s) | 180° C. | 183 |
| Mechanical | Tensile strength (MPa) | 45 |
| physical | Tensile elongation (%) | ≥100 |
| property | Charpy impact strength(kJ/m²) | 3.2 |

The polyester resin composition, and the polyester resin molding and the producing method thereof according to the invention has been described according to the foregoing embodiments and examples, but the invention is not limited to the foregoing embodiments and examples and may encompass various transformations, modifications, and improvements made to the various disclosed elements (including elements disclosed in the Claims, Description, and Drawings) within the scope of the invention and according to the fundamental technical idea of the present invention. Further, various combinations, substitutions, and selections of the various disclosed elements are possible within the scope of the claims of the invention.

Further issues, objectives, and embodiments (including modifications) of the present invention are revealed also from the entire disclosure of the invention including the Claims.

The numerical ranges disclosed herein are to be construed in such a manner that arbitrary numerical values and ranges falling within the disclosed ranges are treated as being concretely described herein, even where not specifically stated.

### INDUSTRIAL APPLICABILITY

The polyester resin composition of the present disclosure has excellent moldability and mechanical physical properties. The polyester resin composition of the present disclosure and molding therefrom can be therefore employed in a wide variety of various molding materials, for example, containers, electrical and electronic components, and automotive materials.

### REFERENCE SIGNS LIST

1 molding
1a opening
2 mold for checking

1. A polyester resin composition, comprising:
a copolymer of a polycarboxylic acid component and a polyol component, wherein the polycarboxylic acid component comprises terephthalic acid and/or a derivative thereof;
the polyol component comprises ethylene glycol and/or a derivative thereof and 2,2-dimethyl-1,3-propanediol and/or a derivative thereof;
a content by percentage of 2,2-dimethyl-1,3-propanediol and/or the derivative thereof is 27 mol % to 55 mol % based on the total amount of the polyol component; and
the composition has an intrinsic viscosity of 0.5 dl/g to 0.6 dl/g.

2. The polyester resin composition according to claim 1, wherein the composition has a melt viscosity at 200° C. of 100 Pa·s to 210 Pa·s.

3. The polyester resin composition according to claim 1, wherein
the composition has having a melt viscosity at 180° C. of 175 Pa·s to 320 Pa·s.

4. The polyester resin composition according to claim 1, wherein
the composition has a tensile elongation of 100% or more.

5. The polyester resin composition according to claim 1, wherein
the composition has a Charpy impact strength of 3 kJ/m² or more.

6. A polyester resin molding, wherein the molding is made by:
melting the polyester resin composition according to claim 1 at a set temperature of 200° C. or below; and
molding the composition.

7. A method of producing a polyester resin molding, comprising:
melting the polyester resin composition according to claim 1 at a set temperature of 200° C. or below; and
filling a mold with the melted polyester resin composition.

8. The method of producing a polyester resin molding according to claim 7, further comprising:
lowering the temperature of the mold to 20° C. to 60° C. to cool and demold the polyester resin composition filled in the mold,
wherein the demolded molding has a portion having a thickness of 2 mm or greater.
